(19) United States
(12) Patent Application Publication
(10) Pub. No.: US 2022/0082003 A1
(43) Pub. Date: Mar. 17, 2022

(54) TEMPERATURE REACTIVE ACOUSTIC PARTICLES FOR MAPPING FRACTURES

(71) Applicant: United States Department of Energy, Washington, DC (US)

(72) Inventors: Philip Leonard, Santa Fe, NM (US); Christopher J. Snyder, Los Alamos, NM (US)

(21) Appl. No.: 17/024,099

(22) Filed: Sep. 17, 2020

(51) Int. Cl. E21B 43/26; C09K 8/80; C09K 8/92; E21B 47/107

(52) U.S. Cl. CPC E21B 43/26; E21B 47/107; C09K 8/92; C09K 8/80

(57) ABSTRACT

The present disclosure provides temperature reactive acoustic particles comprising nitrate esters, organic peroxides, organic azides, nitro compounds, organic nitroamines, or mixtures thereof, which react when exposed to a certain temperature for a certain amount of time generating an acoustic signal. The acoustic signal can be used to generate a geographic evaluation of a geologic formation.

### ACKNOWLEDGEMENT OF GOVERNMENT SUPPORT

This invention was made with United States (U.S.) government support under Contract No. DE-AC52-06NA25396 awarded by the U.S. Department of Energy. The U.S. government has certain rights in the invention.

### PARTIES TO JOINT RESEARCH AGREEMENT

The research work described here was performed under a Cooperative Research and Development Agreement (CRADA) between Los Alamos National Laboratory (LANL) and Chevron under the LANL-Chevron Alliance, CRADA number LA05C10518.

### TECHNICAL FIELD

The present application relates to unconventional fracturing material, and in particular, to temperature reactive acoustic particles and methods of using temperature reactive acoustic particles comprising nitrate esters, organic peroxides, organic azides, nitro compounds, organic nitroamines, or mixtures thereof. The acoustic particles react to form acoustic waves and gas when exposed to elevated temperatures. The acoustic waves can be used to evaluate an unconventional formation.

### BACKGROUND

Hydrofracturing, commonly known as hydraulic fracturing or fracking, is a method of increasing the flow of oil, gas, or other fluids within a rock formation. Hydrofracturing involves pumping a fracturing fluid into a wellbore under high pressure such that fractures form in the rock formation surrounding the wellbore, thus, increasing the permeability of the formation and increasing recovery of oil and gas. However, during recovery the pressure inside the wellbore and against the fracture walls is lower than the pressure applied through the fracturing liquid when forming the fractures. As fractures are formed through high pressure hydraulic forces, fractures are more susceptible to closure due to natural tendency and the forces applied by the surrounding formation during the hydrocarbon recovery period.

In order to keep the fractures open during recovery, proppant is placed in the fractures. Common proppants used are solid particles, commonly ranging from 0.1-2 mm, which are injected into the fractures to prop the fractures open while allowing fluid to flow through the interstitial space. Proppants are commonly mixed into fracturing fluid and injected into the fractures with the fracturing fluid as the fractures are created.

As described above, producing oil using fracturing technology involves preservation of the subsurface with a displacing fluid. However, a variety of failures related to the geometry of the subsurface environment may complicate oil production. Well bores may communicate with one another causing a lack of production from the desired borehole and simultaneous contamination in a nearby system. Also fracturing fluid often fails to access the desired strata or area of the oil-bearing formation, resulting in a lack of production.

### SUMMARY

In general, in one aspect, the disclosure relates to a method for generating acoustic signals in a subterranean formation including adding a temperature reactive acoustic particle to an injection fluid. The temperature reactive acoustic particle includes a nitrate ester, an organic peroxide, organic azide, nitro compound, nitroamine, or a mixture thereof. The temperature reactive acoustic particle is configured to react at a reaction temperature of greater than 110° F. to generate an acoustic signal when the injection fluid is introduced into the subterranean formation. The injection fluid for injecting into a well in a subterranean formation can include a plurality of proppant particles and a plurality of temperature reactive acoustic particles.

These and other aspects, objects, features, and embodiments will be apparent from the following description and the appended claims. Those skilled in the art may use the proppant produced by the systems and techniques provided herein for other applications.

### BRIEF DESCRIPTION OF THE DRAWINGS

The drawings illustrate only example embodiments of temperature reactive acoustic particles (TRAPs) and are therefore not to be considered limiting of its scope, as TRAPs may admit to other equally effective embodiments. The elements and features shown in the drawings are not necessarily to scale, emphasis instead being placed upon clearly illustrating the principles of the example embodiments. The methods described in connection with the drawings illustrate certain steps for carrying out the techniques of this disclosure. However, the methods may include more or less steps than explicitly described in the example embodiments. Two or more of the described steps may be combined into one step or performed in an alternate order. Moreover, one or more steps in the described method may be replaced by one or more equivalent steps known in the art to be interchangeable with the described step(s).

FIG. 1 illustrates a schematic diagram of an oilfield system and wellbore treated with hydrofracturing techniques, in accordance with certain example embodiments.

FIG. 2 illustrates a detailed representation of fractures formed in a wellbore through hydrofracturing techniques and filled with conventional proppant and TRAPs, in accordance with certain example embodiments of the present disclosure.

FIG. 3 illustrates a representation of a well system including an injection well, an observation well, a propped fracture filled with TRAPs and conventional proppant, and an unpropped fracture. The TRAPs are shown to emit acoustic signals which can be detected at the observation well.

FIG. 4 illustrates the experimental setup used to test a TRAP.

FIG. 5 illustrates the resulting acoustic signals from three TRAP experiments.

FIG. 6 illustrates the amplitude over time for acoustic signals from three TRAP experiments.

FIG. 7 illustrates the amplitude and frequency (in logarithmic format) for an acoustic signal and a noise signal from a TRAP experiment.

### DETAILED DESCRIPTION OF EXAMPLE EMBODIMENTS

One general embodiment of the disclosure is a temperature reactive acoustic particle (TRAP) which, when introduced into an oil-bearing formation, thermally reacts and generates an acoustic signal. TRAPs are introduced into the formation with a fracturing fluid and are configured to react when exposed to formation temperatures. When TRAPs react to the formation temperature, the reaction creates sound waves that can be measured as acoustic signals, which are then picked up by an observation well. The detected acoustic signals are then used to create a fracture network map.

### Definitions

As used in this specification and the following claims, the terms “comprise” (as well as forms, derivatives, or variations thereof, such as “comprising” and “comprises”) and “include” (as well as forms, derivatives, or variations thereof, such as “including” and “includes”) are inclusive (i.e., open-ended) and do not exclude additional elements or steps. For example, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Accordingly, these terms are intended to not only cover the recited element(s) or step(s), but may also include other elements or steps not expressly recited. Furthermore, as used herein, the use of the terms “a” or “an” when used in conjunction with an element may mean “one,” but it is also consistent with the meaning of “one or more,” “at least one,” and “one or more than one.” Therefore, an element preceded by “a” or “an” does not, without more constraints, preclude the existence of additional identical elements.

The use of the term “about” generally refers to a range of numbers that one of ordinary skill in the art would consider as a reasonable amount of deviation to the recited numeric values (i.e., having the equivalent function or result). For example, this term can be construed as including a deviation of ±10 percent of the given numeric value provided such a deviation does not alter the end function or result of the value. Therefore, a value of about 1% can be construed to be a range from 0.9% to 1.1%. The term “exactly,” when used explicitly, refers to an exact number.

It is understood that when combinations, subsets, groups, etc. of elements are disclosed (e.g., combinations of components in a composition, or combinations of steps in a method), that while specific reference to each of the various individual and collective combinations and permutations of these elements may not be explicitly disclosed, each is specifically contemplated and described herein. By way of example, if an item is described herein as including a component of type A, a component of type B, a component of type C, or any combination thereof, it is understood that this phrase describes all of the various individual and collective combinations and permutations of these components. For example, in some embodiments, the item described by this phrase could include only a component of type A. In some embodiments, the item described by this phrase could include only a component of type B. In some embodiments, the item described by this phrase could include only a component of type C. In some embodiments, the item described by this phrase could include a component of type A and a component of type B. In some embodiments, the item described by this phrase could include a component of type A and a component of type C. In some embodiments, the item described by this phrase could include a component of type B and a component of type C. In some embodiments, the item described by this phrase could include a component of type A, a component of type B, and a component of type C. In some embodiments, the item described by this phrase could include two or more components of type A (e.g., A1 and A2). In some embodiments, the item described by this phrase could include two or more components of type B (e.g., B1 and B2). In some embodiments, the item described by this phrase could include two or more components of type C (e.g., C1 and C2). In some embodiments, the item described by this phrase could include two or more of a first component (e.g., two or more components of type A (A1 and A2)), optionally one or more of a second component (e.g., optionally one or more components of type B), and optionally one or more of a third component (e.g., optionally one or more components of type C). In some embodiments, the item described by this phrase could include two or more of a first component (e.g., two or more components of type B (B1 and B2)), optionally one or more of a second component (e.g., optionally one or more components of type A), and optionally one or more of a third component (e.g., optionally one or more components of type C). In some embodiments, the item described by this phrase could include two or more of a first component (e.g., two or more components of type C (C1 and C2)), optionally one or more of a second component (e.g., optionally one or more components of type A), and optionally one or more of a third component (e.g., optionally one or more components of type B).

“Hydrocarbon-bearing formation” or simply “formation” refers to the rock matrix in which a wellbore may be drilled. For example, a formation refers to a body of rock that is sufficiently distinctive and continuous such that it can be mapped. It should be appreciated that while the term “formation” generally refers to geologic formations of interest, the term “formation,” as used herein, may, in some instances, include any geologic points or volumes of interest (such as a survey area).

“Unconventional formation” is a hydrocarbon-bearing formation that requires intervention to recover hydrocarbons from the reservoir at commercial flow rates. For example, an unconventional formation includes reservoirs having an unconventional microstructure, such as having submicron pore size (a rock matrix with an average pore size less than 1 micrometer), in which the unconventional reservoir must be fractured under pressure in order to recover hydrocarbons from the reservoir at sufficient flow rates.

The formation may include faults, fractures (e.g., naturally occurring fractures, fractures created through hydraulic fracturing, etc.), geobodies, overburdens, underburdens, horizons, salts, salt welds, etc. The formation may be onshore, offshore (e.g., shallow water, deep water, etc.), etc. Furthermore, the formation may include hydrocarbons, such as liquid hydrocarbons (also known as oil or petroleum), gas hydrocarbons, a combination of liquid hydrocarbons and gas hydrocarbons, etc.

The formation, the hydrocarbons, or both may also include non-hydrocarbon items, such as pore space, connate water, brine, fluids from enhanced oil recovery, etc. The formation may also be divided up into one or more hydrocarbon zones, and hydrocarbons can be produced from each desired hydrocarbon zone.

The term formation may be used synonymously with the term reservoir. For example, in some embodiments, the reservoir may be, but is not limited to, a shale reservoir, a carbonate reservoir, etc. Indeed, the terms “formation,” “reservoir,” “hydrocarbon,” and the like are not limited to any description or configuration described herein.

“Wellbore” refers to a continuous hole for use in hydrocarbon recovery, including any openhole or uncased portion of the wellbore. For example, a wellbore may be a cylindrical hole drilled into the formation such that the wellbore is surrounded by the formation, including rocks, sands, sediments, etc. A wellbore may be used for injection. A wellbore may be used for production. A wellbore may be used for hydraulic fracturing of the formation. A wellbore even may be used for multiple purposes, such as injection and production. The wellbore may have vertical, inclined, horizontal, or a combination of trajectories. For example, the wellbore may be a vertical wellbore, a horizontal wellbore, a multilateral wellbore, or a slanted wellbore. The term wellbore is not limited to any description or configuration described herein. The term wellbore may be used synonymously with the terms borehole or well.

“Injection well,” as used herein, refers to a wellbore that is used to inject a substance, such as a liquid or a gas, into a formation. “Observation well,” as used herein, refers to a wellbore that is used to take measurements on a well. The observation well may only take measurements, or be additionally used for other purposes such as injection or production.

“Temperature reactive acoustic material” or “TRAM,” as used herein, refers to a material, such as a nitrate ester, which creates energy in the form of acoustic waves and gas when exposed to certain temperatures for a period of time. “Temperature reactive acoustic particles,” or “TRAP,” as used here, refers to particles which comprise temperature reactive acoustic material. A TRAP can comprise only temperature reactive acoustic material, or can also comprise additional material such as sensitizers, surfactants, etc. “Prill,” as used herein, refers to a material formed into a pellet or solid globule.

“Acoustic signal,” as used herein, refers to a sound that is produced by the TRAP and detectable at an observation well.

“Injection fluid,” as used herein, refers to any fluid which is injected into a reservoir via a well. The injection fluid may include one or more friction reducers, acids, gelling agents, crosslinkers, breakers, pH adjusting agents, non-emulsifier agents, iron control agents, corrosion inhibitors, biocides, clay stabilizing agents, proppants, or any combination thereof, to increase the efficacy of the injection fluid. “Fracturing fluid” is an injection fluid which is injected into the well under pressure in order to cause fracturing within a portion of the reservoir. Fracturing fluid is injected at pressures above which injection of fluid will cause the rock formation to fracture hydraulically. Exact pressures will depend on the unconventional formation to be fractured, but example pressures are about or greater than 5,000 psi, 10,000 psi, or 15,000 psi.

Unless defined otherwise, all technical and scientific terms used herein have the same meanings as commonly understood by one of skill in the art to which the disclosed invention belongs. Unless otherwise specified, all percentages are in weight percent and the pressure is in atmospheres.

Composition

An embodiment of the disclosure is a TRAP that reacts at elevated temperature to form gas and an acoustic signal. In some embodiments, a TRAP comprises materials that will undergo thermal decomposition, releasing an acoustic signal in the process. In embodiments, TRAPs comprise TRAMs. In some embodiments, the TRAM can be nitrate esters, organic peroxides, organic azides, nitro compounds, organic nitroamines, or mixtures thereof. Nitrate esters include, but are not limited to, erythritol tetranitrate (ETN), pentaerythritol tetranitrate (PETN), nitroglycerine (NG), ethylene glycol dinitrate (EGDN), trimethylolethane trinitrate (TMETN), trimethylol nitromethane trinitrate, nitrocellulose, and mannitol hexanitrate. Organic peroxides include, but are not limited to, diacetone diperoxide (DADP), triacetone triperoxide (TATP), hexamethylene triperoxide diamine (HMTD), and methyl ethyl ketone peroxide (MEKP), or mixtures thereof. Organic azides include, but are not limited to, methyl azide and cyanuric azide, or mixtures thereof. Nitro compounds include, but are not limited to, 2,4,6-trinitrotoluene (TNT), 1,3,5-triamino-2,4,6-trinitrobenzene, 2,4-dinitroanisole (DNAN), 5-nitro-1,2-dihydro-1,2,4-triazol-3-one (NTO), 1,3,5-trinitrobenzene (TNB), picric acid, trinitroaniline, heptanitrocubane, and octanitrocubane, Organic nitroamines include, but are not limited to, cyclotrimethylenetrinitramine (RDX), cyclotetramethylene tetranitramine (HMX), and hexanitrohexaazaisowurtzitane (CL-20), or mixtures thereof. TRAPs may also include one or more of these organic functional groups listed above. For example, a nitro compound may also have an organic nitroamine moiety, such as 2,4,6-trinitrophenylmethylnitramine (tetryl). TRAPs may be used as is, or may be formulated with polymeric materials, binders, resins, stabilizers, sensitizers, surfactants, or mixtures thereof. In embodiments, the TRAP is formed into prills. TRAPs are not co-crystals and are instead physical mixtures.

In embodiments, the TRAM is erythritol tetranitrate (ETN). ETN undergoes deflagration-to-detonation transition (DDT) when heated to its decomposition temperature when unconfined, whereas other explosives will deflagrate when heated unconfined to their decomposition temperatures (including the nitrate esters NG, EGDN, TEGDN, DEGDN, TMETH, BTTN). The decomposition temperature of ETN is 100-150° C. depending on confinement and length of heating. The high brisance of ETN results in a significant acoustic signal generation with a long transmission range underground. ETN is also non-polar molecule that does not dissolve in water. ETN can be mixed with one or more additional materials in order to create a physical mixture, which, in embodiments, has similar explosive properties to pure ETN but with differing physical properties.

In embodiments, the TRAP additionally comprises polymeric materials, including binders and resins, or mixtures thereof. The addition of polymeric materials, binders, and resins can allow for the formation of prills of precise sizes, for example, less than 2 mm. Examples of polymeric materials include aliphatic polymers such as polyethylene or polybutylene, polyesters, polyamides, polydimethylsiloxane, polystyrene and polystyrene copolymers, polyurethanes, fluorinated binders such as PVDF, FK-800, Kel-F, and Viton®, and chlorinated polymers such as PVC and mixtures thereof. In some embodiments, the polymeric materials comprise between 0% and 20% of a final TRAP.

In some embodiments, the TRAP additionally comprises a plasticizer. The addition of plasticizers to the formulation can increase the plasticity, molding capability, and durability of the TRAP. Examples of plasticizers include, but is not limited to, dioctyl-adipate, dioctyl-phthalate, aromatic compounds such as ethylbenzene, ethylene glycol dinitrate, nitroglycerine, trimethylolethane trinitrate, trimethylol nitromethane trinitrate, aliphatic compounds such as decane, non-volatile ethers, esters, amides and other common plasticizers and mixtures thereof. In some embodiments, the plasticizer comprises between 2% and 20% of a final TRAP.

In some embodiments, the TRAP additionally comprises a sensitizer. The addition of a sensitizer can allow the decomposition temperature to be tuned lower than TRAM alone. Examples of sensitizers include radical initiators or organic acids, including, but not limited to, azobisisobutyronitrile (AIBN), benzolyl peroxide, 1,1′-azobis(cyclohexanecarbonitrile), di-tert-butylperoxide, peroxydisulfate salts, and mixtures thereof. In some embodiments, the sensitizer comprises between 0% and 5% of a final TRAP.

In some embodiments, the TRAP additionally comprises a surfactant. The addition of surfactants can be used for the formulation of prills, and the surfactant may or may not be included in the final TRAP itself. Examples of surfactants include, but are not limited to, Tween 85, Span 20, Brig 93, Triton X-15, poly(ethylene glycol), and mixtures thereof. In some embodiments, the surfactants comprise between 0% and 1% of a final TRAP.

In some embodiments, the TRAP comprises at least 50%, 60%, 70%, 80%, or 90% TRAM. The strength of the acoustic signal is dependent on the size of the TRAP and the percentage of TRAM within the TRAP.

The TRAP generates an acoustic signal when the TRAP reaches a certain temperature for a certain amount of time. In some embodiments, the acoustic signal generated has an amplitude between 100 dB to 200 dB and a frequency between 1 Hz to 10,000 Hz. For example, a reacting TRAP could generate an acoustic signal with an amplitude of 150 dB and a frequency of 100 Hz. The acoustic signal can generate energy of between 0.1 J to 100 J.

The TRAPs can be spherical or aspherical, cylindrical or nearly cylindrical, or any geometry which allows incorporation into the fracking fluid. In some embodiments, the TRAPs have diameters that are less than 2.0 mm, less than 1.9 mm, less than 1.8 mm, less than 1.7 mm, less than 1.6 mm, less than 1.5 mm, less than 1.4 mm, less than 1.3 mm, less than 1.2 mm, less than 1.1 mm, less than 1.0 mm, less than 0.9 mm, 0.8 mm, less than 0.7 mm, less than 0.6 mm, less than 0.5 mm, less than 0.4 mm, less than 0.3 mm, or less than 0.2 mm. In some embodiments, the TRAPs are greater than or equal to 20 mesh, 25 mesh, 30 mesh, 35 mesh, 40 mesh, 45 mesh, 50 mesh, 60 mesh, 70 mesh, 80 mesh, 90 mesh, or 100 mesh. In embodiments of the disclosure, the TRAP is stable (non-reacting) under mechanical friction and heat from pumping 80-100 bpm and under pressures of up to 10000 psi. In some embodiments, the TRAP does not react or degrade when exposed to HCl, HF, and H₂S or other anticipated subsurface conditions.

Upon reaching a certain temperature for a certain time reaction of the TRAP occurs. During the reaction the TRAP undergoes conversion from solid to gas, applying energy in the form of an acoustic signal. In some embodiments, the reaction happens at a temperature corresponding to subsurface conditions. For example, the TRAP can react at temperatures greater than or equal to 150° F., 200° F., 250° F., 300° F., or 350° F. In embodiments, the TRAP is not reactive at 100° F. or less. That is, the TRAP is stable at 100° F. In some embodiments, the reaction happens after being exposed to subsurface temperatures. For example, the reaction can happen after more than a minute, an hour, two hours, four hours, six hours, 12 hours, a day, two days, three days, four days, five days, six days or a week after being constantly exposed to subsurface temperatures. In embodiments, all TRAP injected into a formation are decomposed. That is, no TRAPs are recovered during production.

ETN prills may be made from either flash cooling of a slurry of molten ETN in water, or through a slurry method. The flash cooling method involves heating a stirred slurry (350 rpm) of ETN and water to 58° C. so that the ETN is completely molten. Acetone, ethanol, or another suitable organic solvent may be added in small quantities to reduce the surface tension of the water. Ice water is then dumped into the slurry, resulting in the formation of solid, spherical prills. The ETN prills were then filtered on a Buchner funnel, collected, and dried in air. The slurry method involves suspending ETN in water at 50° C. with 0.1% Tween 85. FK-800, dissolved in ethyl acetate, is then added to the ETN, and the resulting slurry is stirred at 300 rpm until the ethyl acetate has evaporated and prills have formed. The prills are filtered, collected, and dried in air.

Prior to injection into a well, the TRAPs are added to a fracturing fluid, forming a fracturing fluid including the TRAPs. The TRAPs can be added into the fracturing fluid in any method currently used to add conventional proppant into fracturing fluid. The TRAPs may be added directly into the fracturing fluid, or the TRAPs may be suspended in water prior to being added to the fracturing fluid. In embodiments, the fracturing fluid is fresh water, well water, brackish water, sea/ocean water, deionized water, distilled water, treated or untreated waste water, treated or untreated produced water, slickwater, or combinations thereof. In some embodiments, the fracturing fluid includes conventional proppant. In embodiments, the TRAPs are mixed into the fracturing fluid at a ratio of 1 TRAP per about 1000 proppant particles to about 1 TRAP per about 50000 proppant particles. In certain embodiments, the TRAPs are mixed into the fracturing fluid at a ratio of about 1 TRAP per about 10000 proppant particles. The TRAPs can be the same size as a proppant or may be different sizes.

Method of Use

Example embodiments directed to the method of using TRAPs will now be described in detail with reference to the accompanying figures. Like, but not necessarily the same or identical, elements in the various figures are denoted by like reference numerals for consistency.

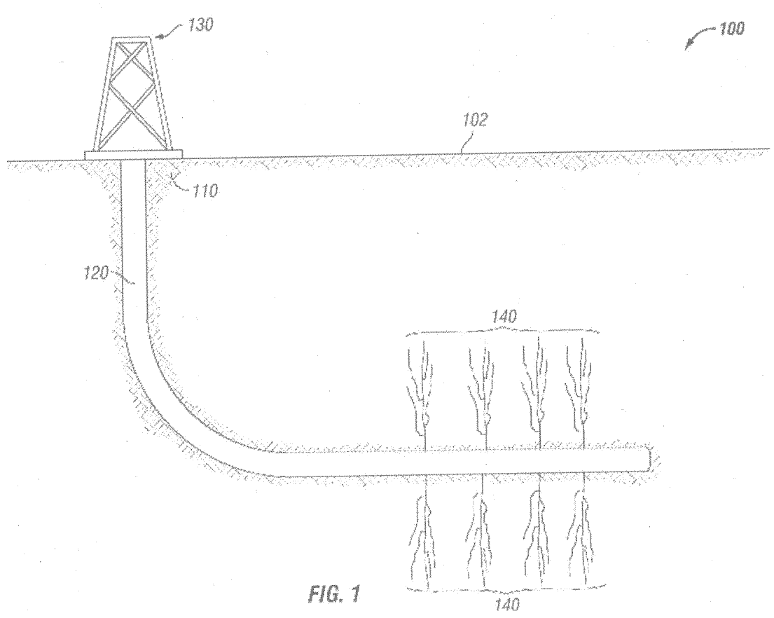

Referring to FIG. 1, which illustrates an example embodiment of an oilfield system 100, a wellbore 120 is formed in a subterranean formation 110 using field equipment 130 above a surface 102. For on-shore applications, the surface 102 is ground level. For offshore applications, the surface 102 is the sea floor. The point where the wellbore 120 begins at the surface 102 can be called the entry point. The subterranean formation 110 in which the wellbore 120 is formed can include one or more of a number of formation types, including but not limited to shale, limestone, sandstone, clay, sand, and salt. In certain embodiments, the subterranean formation 110 can also include one or more reservoirs in which one or more resources (e.g., oil, gas, water, steam) can be located. One or more of a number of field operations (e.g., drilling, setting casing, extracting production fluids) can be performed to reach an objective of a user with respect to the subterranean formation 110.

The example oilfield system 100 of FIG. 1 further includes fractures 140 formed through a hydrofracturing process. In an example hydrofracturing process, a fluid is injected into the wellbore 120 with high enough pressure to create fractures 140 in the surrounding formation 110. Such a process increases the surface area in the formation 110 from which oil and gas can flow. In certain example embodiments, the fluid includes conventional proppants, which are deposited into the fractures and hold the fractures open, allowing oil and gas to flow from the fractures 140 into the wellbore 120 so that it can be recovered, and also comprises TRAPs. TRAPs and convention proppants are mixed into an injection fluid prior to injection into a portion of an unconventional reservoir forming a fracturing fluid. The fracturing fluid is then pumped into a well under high pressure causing fractures 140 to form and allowing the conventional proppant and the TRAPs to penetrate the rock matrix within the fractures.

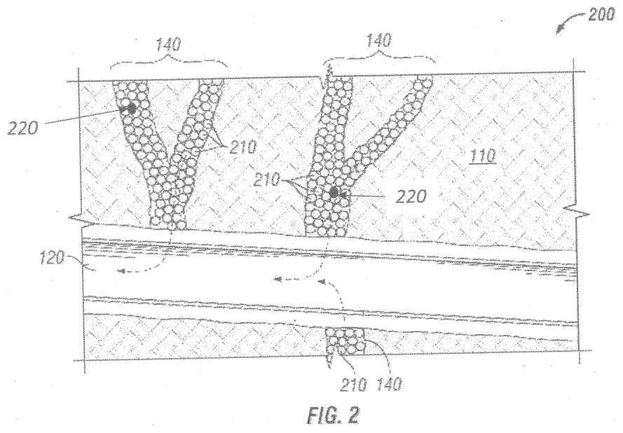

FIG. 2 illustrates a detailed representation 200 of fractures 140 filled with a conventional proppant 210 and TRAPs 220, in accordance with certain example embodiments of the present disclosure. It should be noted that the representation 200 is not to scale and dimensions and ratios are exaggerated for illustrative purposes. Referring to FIG. 2, the conventional proppant 210 is disposed within the fractures 140 and supports the fracture walls to keep the fractures 140 open. The TRAPs 220 are mixed with the conventional proppant 210 and are distributed throughout the fracture network with the conventional proppant 210. As such, once TRAPs 220 react, the acoustic signals are generated throughout the fracture network, giving an indication of where the propped fractures occur once the acoustic signals are detected and processed.

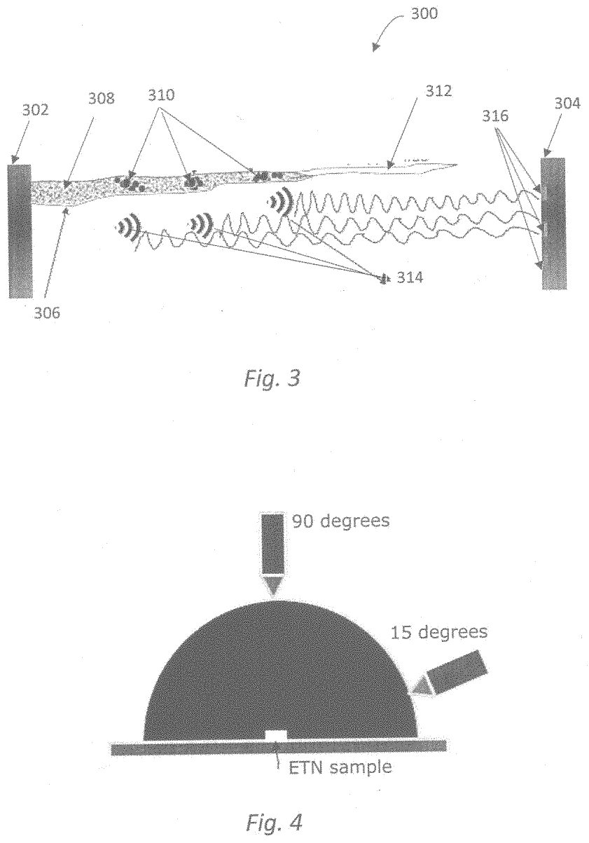

FIG. 3 shows another example oilfield system 300 including an injection well 302, an observation well 304, a fracture 306 filled with conventional proppant 308 and TRAPs 310, and an unfilled fracture 312. Once inside the rock matrix and exposed to elevated temperatures, TRAPs react to form gas and produce an acoustic signal 314. The acoustic signals 314 are then detected at detectors 316 in the observation well 304 and the acoustic signals 314 are used to create a map of the fractures within the formation.

The acoustic signals can be detected at an observation well, which can be located between 500-1000 feet from the injection well. A seismic receiver, which can detect energies between 0.001 J and 16 J, can be located in the observation well and can detect the acoustic signal. Geophones, hydrophones, and microphones may also be used as detectors to detect the acoustic signals and map the formation. The amplitude, frequency, and direction of the detected acoustic signals can be used to create a map of the fractures in the formation.

For a geological system with multiple sensors, the difference between time and amplitude of signals from the sub-surface sources can be used to locate point sources in a formation using acoustic triangulation. The preferred embodiment would use one or more sound or pressure sensors on the well pipe as a reference for two or more sensors deployed throughout the active field. Higher frequency signals may be used to detect fractures close to the sensors whereas lower frequency signals will be detectable at large distances between the sensors and the fracture.

The TRAPs can be added into the injection fluid in the same way any proppant can be added. The amount, size, or reaction temperature of the TRAPs can be optimized for each unconventional reservoir. For example, a TRAP can be tested at a specific reservoir temperature and salinity, and with a specific injection fluid. Actual native reservoir fluids may also be used to test the reaction of the TRAPs. The temperature of specific reservoirs can be between 110-350° F., such as between 110-150° F., 150-200° F., 200-250° F., 250-300° F., 300-350° F., 110-240° F., or 240-350° F. The salinity of specific reservoirs can be between 5,000 ppm TDS to 250,000 ppm TDS. Based on the results of these tests, the TRAP and any other additional components of the solution can be optimized.

### EXAMPLES

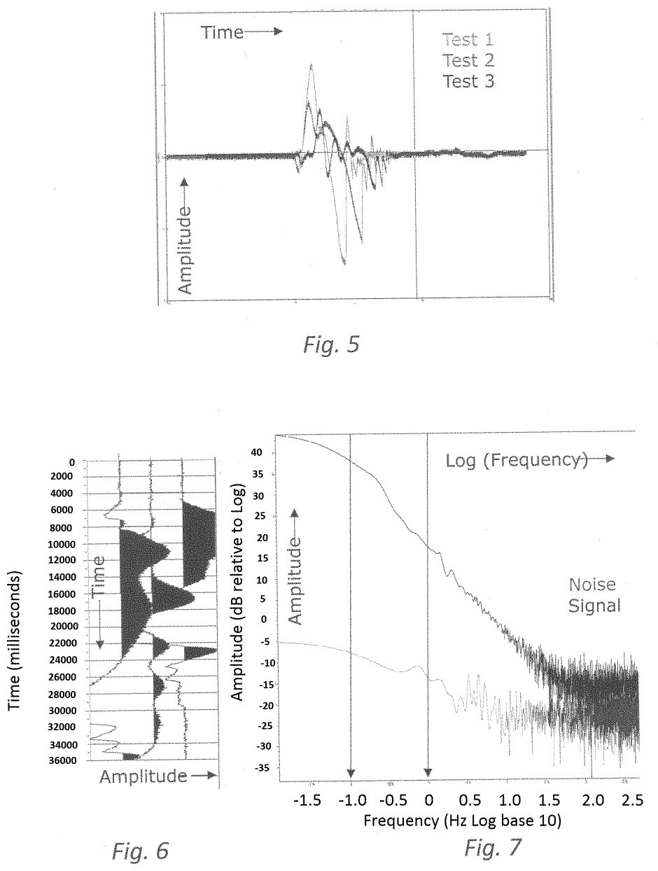

Referring to FIG. 4, an example arrangement for an experimental test of the TRAP is illustrated. The ETN sample represents the TRAP located in a fracture proximate to the injection well. The ETN was placed within a 6″ hemisphere containing a mixture of sand and water. The ETN sample was heated from below, until it detonated, releasing an audible acoustic signal. The geophones within the hemisphere recorded the acoustic signal, shown in FIG. 5.

Referring now to FIGS. 5-7, example data for acoustic signals measured during experimental testing is shown. FIG. 5 shows the change in amplitude over time for acoustic signals measured during three experimental tests.

FIG. 5 shows the raw waveform data from acoustic signals that were generated from three TRAP experiments. This data was used to create a map of the amplitude over time for acoustic signals (FIG. 6). Data from FIG. 5 was also used to generate FIG. 7, which shows the amplitude as a function of frequency (in logarithmic format) for an acoustic signal from a TRAP experiment, showing the good signal-to-noise ratio.

The description and illustration of one or more embodiments provided in this application are not intended to limit or restrict the scope of the invention as claimed in any way. The embodiments, examples, and details provided in this disclosure are considered sufficient to convey possession and enable others to make and use the best mode of the claimed invention. The claimed invention should not be construed as being limited to any embodiment, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and alternate embodiments falling within the spirit of the broader aspects of the claimed invention and the general inventive concept embodied in this application that do not depart from the broader scope. For instance, such other examples are intended to be within the scope of the claims if they have structural or methodological elements that do not differ from the literal language of the claims, or if they include equivalent structural or methodological elements with insubstantial differences from the literal language of the claims, etc. All citations referred to herein are expressly incorporated by reference.

What is claimed is:

1. A method for generating acoustic signals in a subterranean formation, comprising:
adding a temperature reactive acoustic particle to an injection fluid,
wherein the temperature reactive acoustic particle comprises a nitrate ester, an organic peroxide, organic azide, nitro compound, nitroamine, or a mixture thereof,
wherein the temperature reactive acoustic particle is configured to react at a reaction temperature of greater than 110° F. to generate an acoustic signal; and
introducing the injection fluid into the subterranean formation.

2. The method of claim 1, wherein the injection fluid is introduced into the subterranean formation at a pressure greater than 5,000 PSI, 8,000 PSI, or 10,000 PSI.

3. The method of claim 1, wherein a temperature of the subterranean formation is above 110° F., 130° F., 150° F., 175° F., 200° F., 250° F., 300° F., or 350° F.

4. The method of claim 1, wherein the nitrate ester is erythritol tetranitrate (ETN), pentaerythritol tetranitrate (PETN), nitroglycerine (NG), ethylene glycol dinitrate (EGDN), trimethylolethane trinitrate (TMETN), trimethylol nitromethane trinitrate, nitrocellulose, and mannitol hexanitrate, or a mixture thereof.

5. The method of claim 1, wherein the organic peroxide is diacetone diperoxide (DADP), triacetone triperoxide (TATP), hexamethylene triperoxide diamine (HMTD), and methyl ethyl ketone peroxide (MEKP), or a mixture thereof.

6. The method of claim 1, wherein the temperature reactive acoustic particle comprises at least 50% of the nitrate ester, the organic peroxide, or the mixture thereof.

7. The method of claim 1, wherein the temperature reactive acoustic particle additionally comprises polymeric material, binder, resin, stabilizer, sensitizer, surfactant, or a mixture thereof.

8. The method of claim 1, wherein the temperature reactive acoustic particle is less than 2.0 mm, 1.8 mm, 1.6 mm, 1.4 mm, 1.2 mm, 1.0 mm, 0.8 mm, 0.6 mm, 0.4 mm, 0.2 mm, or 0.1 mm in diameter.

9. The method of claim 1, further comprising detecting the acoustic signal.

10. The method of claim 1, wherein the injection fluid comprises a plurality of temperature reactive acoustic particles and wherein the plurality of temperature reactive acoustic particles generate a plurality of acoustic signals.

11. The method of claim 10, further comprising generating a subterranean map of fractures in the subterranean formation from the plurality of acoustic signals.

12. The method of claim 1, wherein the injection fluid additionally comprises a proppant.

13. The method of claim 1, wherein the temperature reactive acoustic particle does not comprise a metal.

14. The method of claim 1, wherein the acoustic signal generated by the temperature reactive acoustic particle has an amplitude between 100 dB to 200 dB and having a frequency between 1 Hz to 10,000 Hz.

15. An injection fluid composition for injecting into a well in a subterranean formation, the injection fluid composition comprising:
a plurality of proppant particles; and
a plurality of temperature reactive acoustic particles, wherein the plurality of temperature reactive acoustic particles comprise a nitrate ester, an organic peroxide, or a mixture thereof, and wherein the plurality of temperature reactive acoustic particles generate acoustic signals at a reaction temperature of greater than 110° F.

16. The injection fluid composition of claim 15, wherein the nitrate ester is erythritol tetranitrate (ETN), pentaerythritol tetranitrate (PETN), nitroglycerine (NG), ethylene glycol dinitrate (EGDN), trimethylolethane trinitrate (TMETN), trimethylol nitromethane trinitrate, nitrocellulose, and mannitol hexanitrate, or a mixture thereof.

17. The injection fluid composition of claim 15, wherein the organic peroxide is diacetone diperoxide (DADP), triacetone triperoxide (TATP), hexamethylene triperoxide diamine (HMTD), and methyl ethyl ketone peroxide (MEKP), or a mixture thereof.

18. The injection fluid composition of claim 15, wherein the ratio of the plurality of temperature reactive acoustic particles to the plurality of proppant particles is within the range of 0.001 to 0.00002.

19. The injection fluid composition of claim 15, wherein each of the plurality of temperature reactive acoustic particles is less than 2.0 mm, 1.8 mm, 1.6 mm, 1.4 mm, 1.2 mm, 1.0 mm, 0.8 mm, 0.6 mm, 0.4 mm, 0.2 mm, or 0.1 mm in diameter.

20. The injection fluid composition of claim 15, wherein the acoustic signals generated by the plurality of temperature reactive acoustic particles have an amplitude between 100 dB-200 dB and a frequency between 1 Hz-10,000.
